(19) United States
(12) Patent Application Publication
(10) Pub. No.: US 2021/0273606 A1
(43) Pub. Date: Sep. 2, 2021

(54) SOLAR PANEL SYSTEM

(71) Applicant: IBIS Power Holding B.V., Eindhoven (NL)

(72) Inventor: Alexander Boudewijn SUMA, Eindhoven (NL)

(21) Appl. No.: 17/263,649

(22) PCT Filed: Jul. 31, 2019
(86) PCT No.: PCT/NL2019/050506

§ 371 Date: Jan. 27, 2021

(30) Foreign Application Priority Data
Aug. 1, 2018 (NL) 2021417

(51) Int. Cl. H02S 40/42; H02S 40/30

(52) U.S. Cl. CPC H02S 40/425; H02S 40/30

(57) ABSTRACT

The present invention relates to a solar panel system, comprising an array of solar panels, the array essentially arranged parallel to and a distance from the plane of a substantially flat support surface, such as a roof or the sea surface, each solar panel inclined with respect to the array and thus to the flat surface, at least one air inlet, between the support surface and the array, at least one air outlet between adjacent solar panels in the array, characterized in that a duct for air is formed from the air inlet to the at least one air outlet, by at least two walls that extend from the support surface toward the plane of the array and flank the space defined between the support surface and the array at two opposite sides, adjacent to a side that comprises the at least one air inlet.

The present invention relates to a solar panel system. More in particular, the invention relates to an array of solar panels, arranged on an essentially flat surface, such as a flat rooftop.

It has become common to use flat surfaces for the generation of electric power by means of solar panels. These surfaces provide the option to place a relatively large number of solar panels, that can be arranged such that they are inclined towards the sun, in order to maximize the yield of electric energy during a maximum hours per day.

Besides the positioning of the panels with respect to the course of the sun, ambient temperature has an influence on the efficiency of the solar panels. Panels function optimally with a high light intensity, and a relatively low temperature. Most of the time however, the ambient temperature is rater high at the moments when the light intensity is high, and when the temperature is lower, the light intensity usually is too. Recent summers have shown increasing temperature patterns where temperature records have been broken repeatedly. Despite the commons assumption, solar panels produce less energy during those days, while the climate control energy demand is highest to keep supporting indoor comfort. Cooling the solar panels at times of high light intensity is a way to increase efficiency, and can be done in various ways.

Active cooling with for instance fluids or the application of bodies of materials with a large heat capacity are known in the art. However, this has the disadvantage of being complex, requiring (availability of) energy (sources) and fluid cooling infrastructure, and as a result, being less cost attractive.

It is a goal of the present invention to take away the disadvantages of the prior art and to provide an alternative to the known systems.

The present invention thereto provides a solar panel system, comprising an array of solar panels, the array essentially arranged parallel to and a distance from the plane of a substantially flat support surface, such as a roof or the sea surface, each solar panel inclined with respect to the array and thus to the flat surface, at least one air inlet, between the support surface and the array and at least one air outlet between adjacent solar panels in the array, wherein a duct for air is formed from the air inlet to the at least one air outlet, by at least two walls that extend from the support surface to the array and flank the space defined between the support surface and the array. Preferably all solar panels are equipped with an air outlet between adjacent solar panels.

By providing the solar panels at a distance from the support surface, a space is created between the solar panels and the support, through which space air is enabled to flow. The air is guided from the air inlet to the at least one air outlet, by the duct formed by the support surface, the walls, and the surfaces of the solar panels themselves. In most cases, this duct may thus have a tubular shape, with an essentially rectangular cross section in the direction of air flow. The bottom side of the solar panels may thus be uncovered, in order to allow air to flow along them directly.

The air flow itself is automatically created, by ambient air pressure and local weather conditions. In particular when the solar panel system according to the present invention is arranged on a rooftop of building that is higher than its surroundings, or for instance floating on the sea, an air flow is easily obtained. When positioning the system according to the invention on a rooftop, the air inlet may evidently be positioned toward the direction from where wind is blowing in general. The solar panel array structure may extend over the façade or wall of the hosting structure so that more wind flow is captured to be directed inward. Such configuration is described in the international patent application WO2018012964 by the same applicant.

In a preferred embodiment, the duct may be essentially or completely closed, except for the air inlet and the at least one air outlet.

In that case, the air outlet between adjacent solar panels and the outlet between the support surface and the array are the sole outlets for air. Such configuration ensures that the entire air flow is directed toward the air outlet between adjacent solar panels, or in case its present, also partly through the air outlet between the support surface and the array.

When the solar panel system according to the invention comprises an air outlet between the support surface and the array, an airflow through the duct may be created, that may be used for generating electric power when a generator is arranged in the duct. Otherwise, the outlet may provide the advantage that the risk of airflow that becomes too high is limited, or that the airflow can even be controlled when the area of the outlet opening is variable. Such air outlet between the support surface and the array may preferably be arranged at the opposite side from air inlet.

In a further embodiment of the present invention, the air inlet may have a spoiler that directs wind toward the at least one air outlet between adjacent solar panels, or, if several outlets between adjacent panels are available, toward those several outlets. Such spoiler may for instance be inclined with respect to the support, and in particular be directed to the array of solar panels, to guide the air along the bottom surfaces of the solar panels.

In an advanced embodiment, the spoiler is movable in order to amend the angle of inclination. It may for instance be rotatable with respect to an axis of rotation, that may essentially coincide or lie in the plane of the support surface. The spoiler itself may comprise a plane, flat or curved, for deflecting the air flow. The solar panel system may further be configured for adjusting the angle the spoiler has with respect to the support surface in dependence of the speed or force of air at the air inlet. A configuration for adjusting the angle for instance comprises a spring, configured and or directed to increase the angle of inclination when no force is exerted by an incoming air flow. The stronger the air flow, the smaller the angle, so that the air is less directly forced toward the solar panels.

The solar panel system may also comprise a second spoiler at the air outlet between the support surface and the array. Such second spoiler may also be used to control the amount of mass flow or in particular the fraction of air that passes through the duct to the air outlet between the support surface and the array, and the amount or fraction that passes through the air outlets between adjacent solar panels. Solar panel system according to claim 9, wherein the second spoiler is movable between a first position wherein air flow through the outlet opening is allowed and a second position wherein air flow is prohibited in order to force air to flow out via the at least one outlet between adjacent solar panels in the array.

In embodiments where the solar panel system according to the invention comprises multiple air outlets between adjacent solar panels in the array, the area of the outlets may be chosen proportional to the distance between the air inlet and the respective air outlet, to allow an even air flow along each solar panel. Generally, the airflow follows a path that causes the least resistance, which may lead to the undesired situation that relatively more air flows along solar panels close to the air inlet than along solar panels further from the air inlet.

To avoid a too high pressure, the solar panel system according to the invention comprises an over pressure valve, which may be integrated in an air outlet between adjacent solar panels.

In a further embodiment, the solar panel system may comprise or in particular may house an air conditioning system, arranged in the shadow of the array of solar panels. Herewith the shadow provided by the solar panels is taken advantage of. An exhaust for draining heat from the air conditioning system is preferably arranged such that it does not discharge hot air in the air stream to cool the solar panels.

In yet another embodiment, the solar panel system comprises a spherical spoiler below each panel to increase the air flow. These spherical spoilers may preferably be placed beneath the centre of the solar panels, where the temperature of the panels becomes the highest, in order to guide as much wind flux along the panels for cooling them. The system may also comprise a smog filter, which may be an electric smog filter comprising at least one cathode and anode, configured to remove particles in the air flow by means of magnetic attraction. Such electric smog filter may be placed after a generator that may form part of any embodiment of the present invention. An urban or any other wind flow interacting with the hosting structure is redirected between the solar array and bottom surface where it is led through, possibly first a generator, a cathode anode smog filter array after which it release cleaner air into the environment. In the figures, like parts are referred to with like reference numerals.

The invention will now be elucidated into more detail with reference to the following figures, in which:

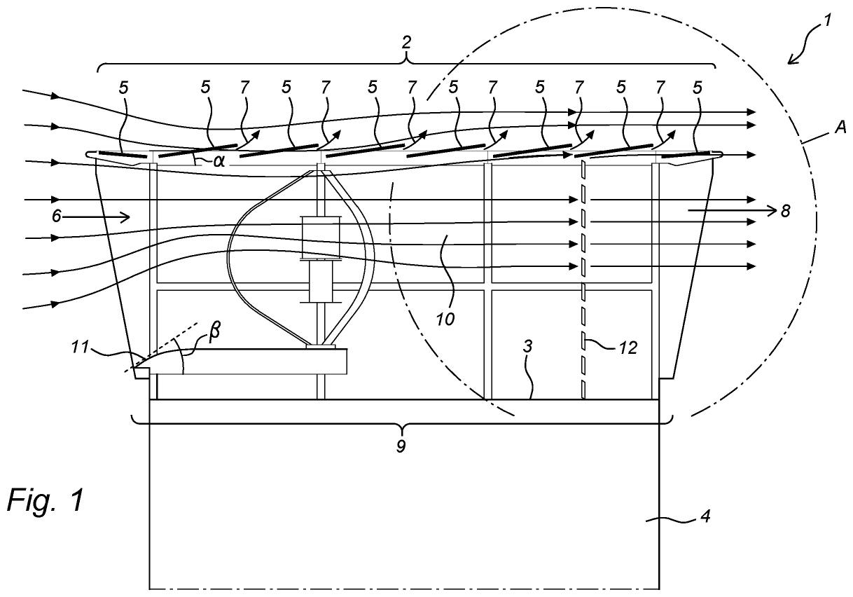

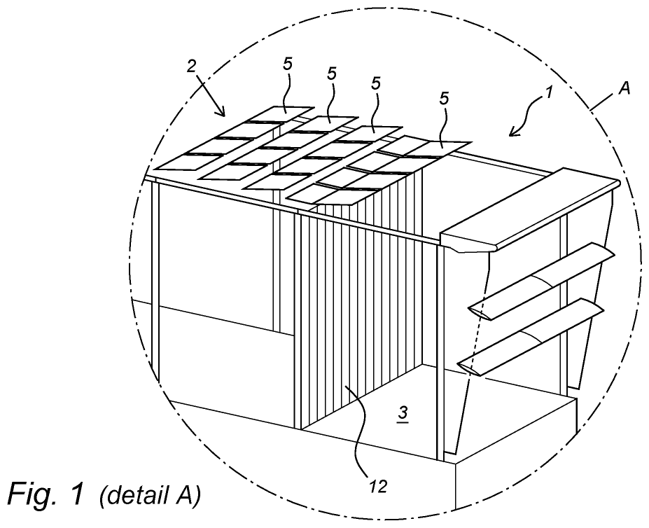

FIG. 1 shows a schematic side view of a first embodiment of the present invention;

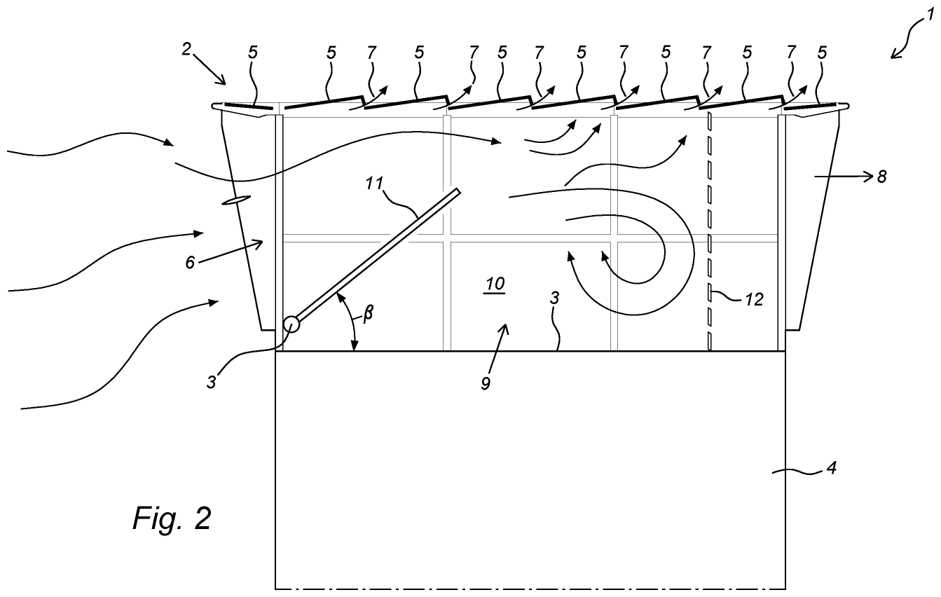

FIG. 2 shows a schematic side view of a second embodiment of the present invention;

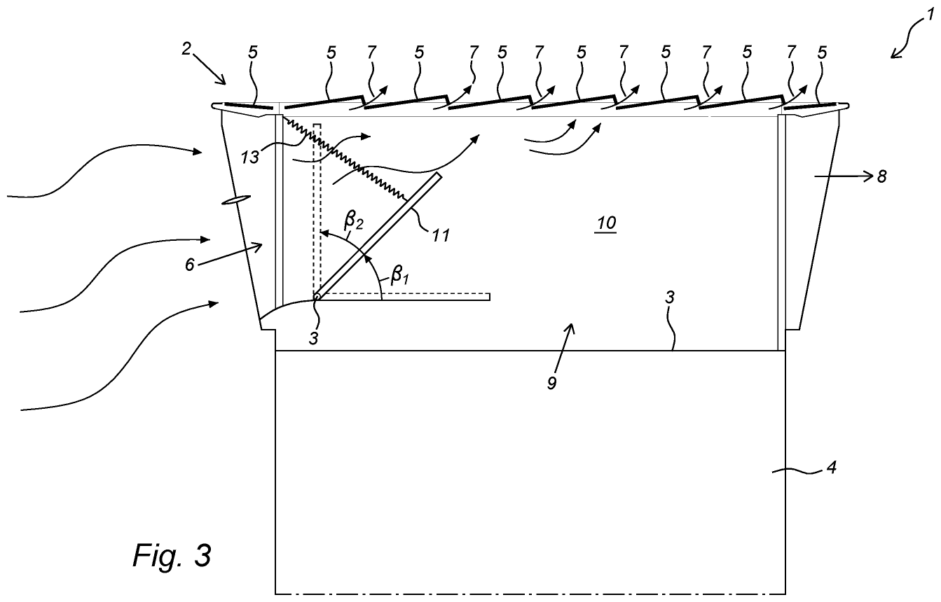

FIG. 3 shows a schematic side view of a third embodiment of the present invention;

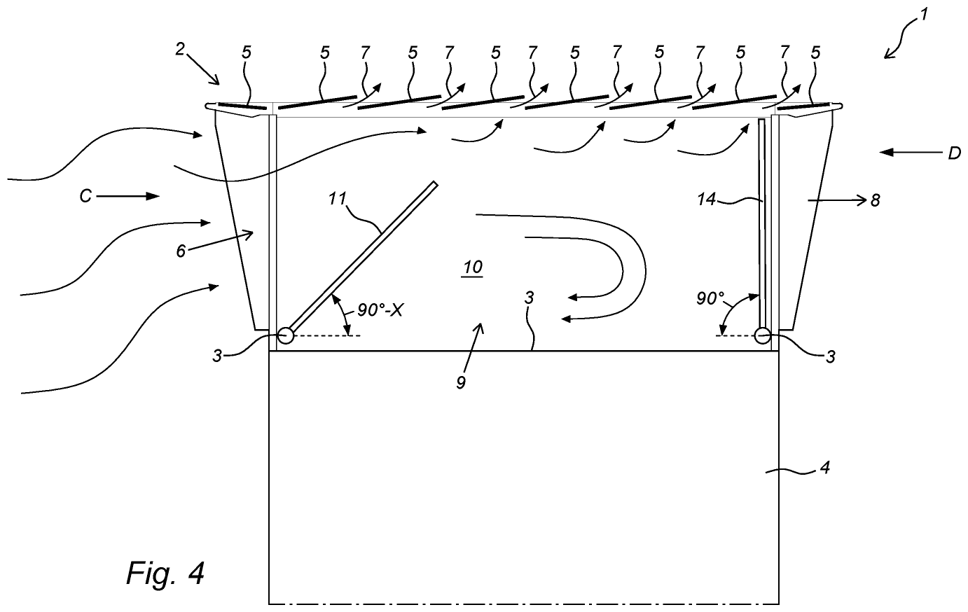

FIG. 4 shows a schematic side view of a fourth embodiment of the present invention;

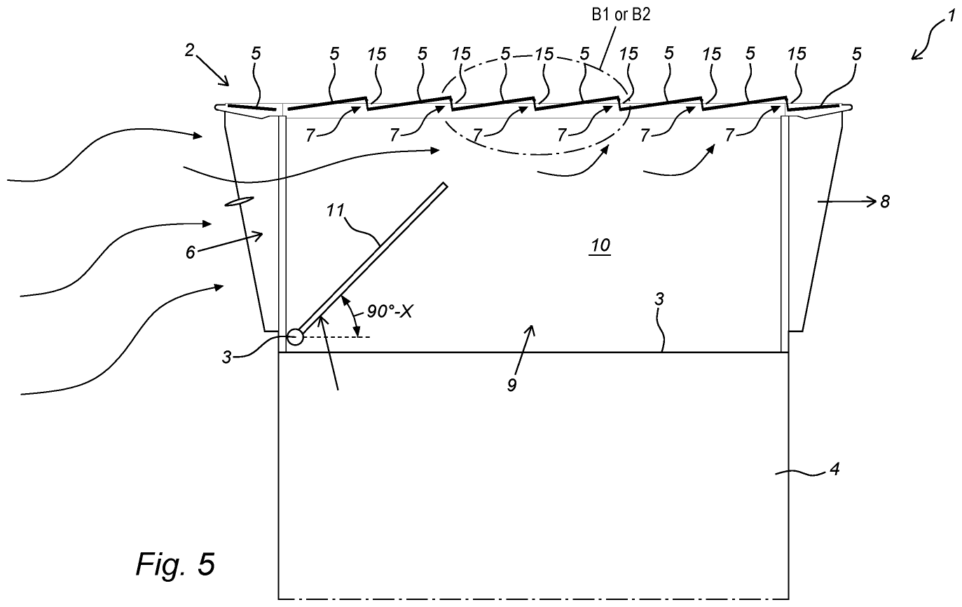

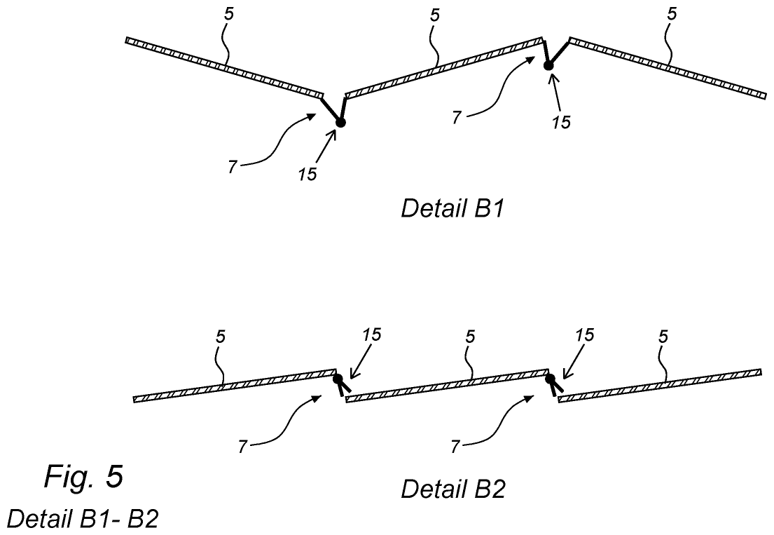

FIG. 5 shows a schematic side view of a fifth embodiment of the present invention;

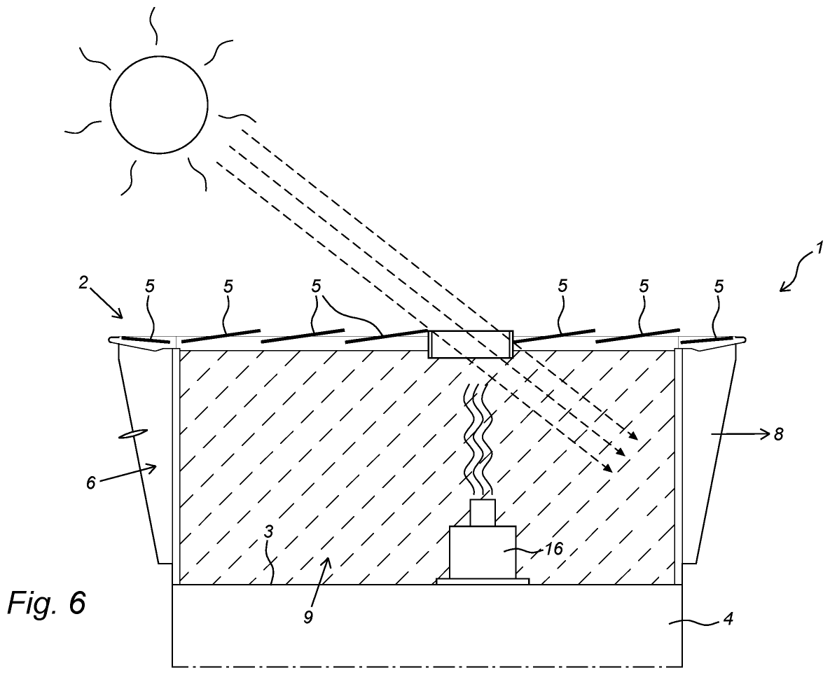

FIG. 6 shows a schematic side view of a sixth embodiment of the present invention;

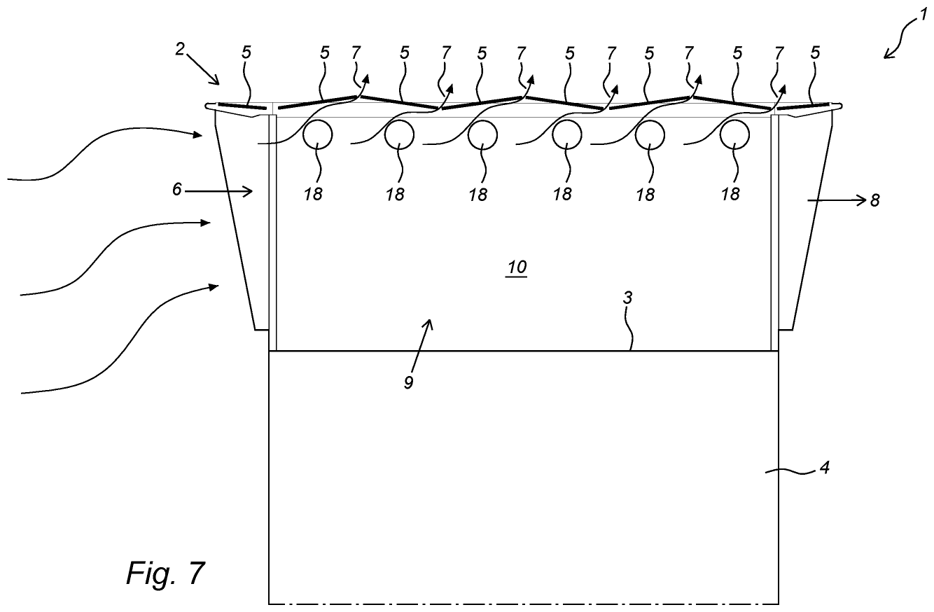

FIG. 7 shows a schematic side view of a seventh embodiment of the present invention; and

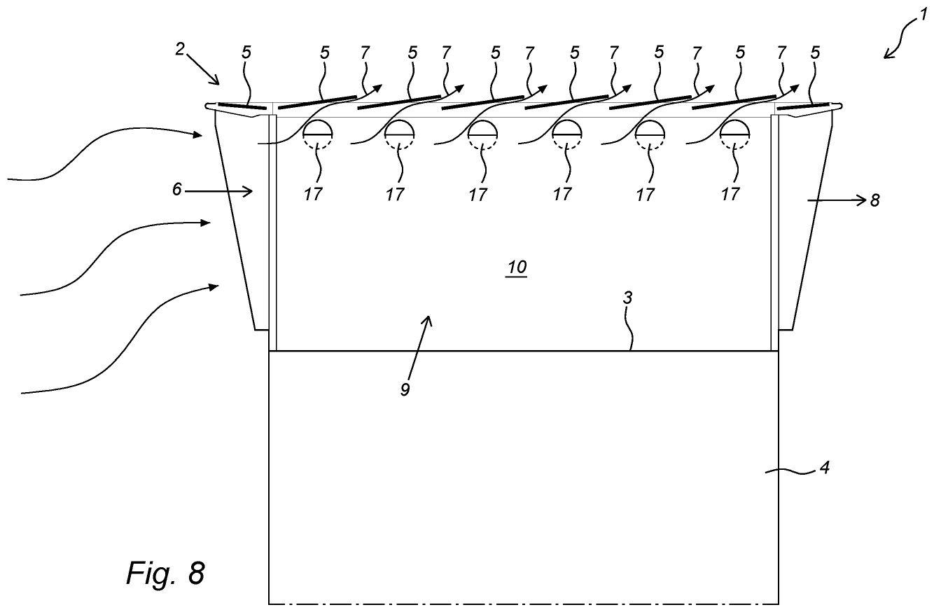

FIG. 8 shows a schematic side view of a eighth embodiment of the present invention.

FIG. 1 shows a schematic side view of a first embodiment 1 of a solar panel system of the present invention. The system comprises an array 2 of solar panels 5, the array essentially arranged parallel to and a distance from the plane of a substantially flat support surface 3, in the example formed by, but in general not limited to a roof of a building 4, each solar panel 5 inclined at an angle alpha with respect to the array 2 and thus to the flat surface 3. In the example given, all panels 5 are inclined under the same angle alpha, but that is not necessary for the present invention to function. The system further comprises at least one air inlet 6, between the support surface 3 and the array 2, and multiple air outlets 8 between adjacent solar panels 5 in the array 2. A duct 9 for air is formed from the air inlet 6 to the air outlets 7 and 8, by at least two walls 10 that extend from the support surface 3 toward the plane of the array 2 and flank the space defined between the support surface 3 and the array 2 at two opposite sides, adjacent to a side that comprises the at least one air inlet 6. In the example shown, the duct 9 closed, except for the air inlet 6 and the air outlets 7 and 8. The air outlet 8 is arranged between the support surface 3 and the array 2, at the opposite side from air inlet 6.

The solar panel system comprises a spoiler 11 that directs wind toward the air outlets 7, wherein the spoiler 11 is inclined under an angle beta with respect to the support 3, in particular directed to the array 2. Detail A shows a three-dimensional representation of a detail of the figure, wherein also a smog filter 12 present in the duct is shown.

FIG. 2 shows a schematic side view of a second embodiment of the present invention wherein the spoiler is movable in order to amend the angle beta of inclination. The system may be configured for adjusting the angle beta in dependence of the speed or force of air at the air inlet 6.

FIG. 3 shows how adjusting the angle beta in dependence of the speed or force of air at the air inlet 6 can be realized in a practical embodiment, comprising a spring 13, configured to increase the angle of inclination beta.

FIG. 4 shows an embodiment comprising a second spoiler 14 at the air outlet between the support surface and the array. The second spoiler 14 is movable between a first position wherein air flow through the outlet opening 8 is allowed (not shown) and a second position (shown) wherein air flow is prohibited in order to force air to flow out via outlets 7 between adjacent solar panels in the array. The situation shown corresponds to an air flow from the direction C. When the air flows from the direction D, spoiler 14 will rotate as to open air outlet 8, which then becomes an inlet, and to close air inlet 6 by means of spoiler 11.

FIG. 5 shows multiple air outlets between adjacent solar panels in the array, wherein the area 15 of the outlets is proportional to the distance between the air inlet 6 and the respective air outlet 7, to allow an even air flow along each solar panel. The area 15 of the outlets 7 is defined by over pressure valves, which may be formed by (flexible) shutters with different surface areas.

FIG. 6 shows a solar panel system comprising an air conditioning system 16, arranged in the shadow of the array of solar panels 5, wherein an exhaust is arranged such that it is not in the air stream to cool the solar panels.

FIG. 7 shows spherical spoilers 18 below each solar panel 5 to increase the air flow.

FIG. 8 shows that also half-spherical spoilers 17 may be applied to obtain the same effect of (at least locally) increased air flow.

All features shown in embodiments may be combined with features from embodiments. The figures in this application are in no way limiting the scope of protection, as defined in the following claims.

1. A solar panel system, comprising:
an array of solar panels, the array essentially arranged parallel to and a distance from the plane of a substantially flat support surface, such as a roof or the sea surface, each solar panel inclined with respect to the array and thus to the flat surface, with;
at least one air inlet, between the support surface and the array;
at least one air outlet between adjacent solar panels in the array;
characterized in that
a duct for air is formed from the air inlet to the at least one air outlet, by at least two walls that extend from the support surface toward the plane of the array and flank the space defined between the support surface and the array at two opposite sides, adjacent to a side that comprises the at least one air inlet; and
wherein the air inlet comprises a spoiler that directs wind toward the at least one air outlet, wherein the spoiler is inclined with respect to the support and
wherein the spoiler is movable in order to amend the angle of inclination.

2. The solar panel system according to claim 1, comprising a further air outlet between the support surface and the array.

3. The solar panel system according to claim 1, wherein the air outlet between adjacent solar panels and the outlet between the support surface and the array are the sole outlets for air.

4. (canceled)

5. (canceled)

6. The solar panel system according to claim 1, configured for adjusting the angle in dependence of the speed or force of air at the air inlet.

7. The solar panel system according to claim 6, wherein the configuration for adjusting the angle comprises a spring, configured to increase the angle of inclination.

8. The solar panel system according to claim 2, comprising a second spoiler at the further air outlet between the support surface and the array.

9. The solar panel system according to claim 8, wherein the second spoiler is movable between a first position wherein air flow through the outlet opening is allowed and a second position wherein air flow is prohibited in order to force air to flow out via the at least one outlet between adjacent solar panels in the array.

10. The solar panel system according to claim 1, comprising multiple air outlets between adjacent solar panels in the array, wherein the area of the outlets is proportional to the distance between the air inlet and the respective air outlet, to allow an even air flow along each solar panel.

11. The solar panel system according to claim 1, comprising an over pressure valve.

12. The solar panel system according to claim 1, comprising an air conditioning system, arranged in the shadow of the array of solar panels, wherein an exhaust is arranged such that it is not in the air stream to cool the solar panels.

13. The solar panel system according to claim 1, comprising a spherical spoiler below each panel to increase the air flow.

14. The solar panel system according to claim 1, comprising a smog filter.

15. The solar panel system according to claim 14, wherein the smog filter comprises a cathode and anode.

16. The solar panel system according to claim 1, comprising an electric generator, arranged in the duct.
